(19) United States
(12) Patent Application Publication
(10) Pub. No.: US 2025/0123526 A1
(43) Pub. Date: Apr. 17, 2025

(54) DUAL DISPLAY DEVICE

(71) Applicant: ELECTRONICS AND TELECOMMUNICATIONS RESEARCH INSTITUTE, Daejeon (KR)

(72) Inventors: Doo-Hee CHO, Daejeon (KR); Tae-Youb KIM, Daejeon (KR); Chil Seong AH, Daejeon (KR); Ji-Young OH, Daejeon (KR)

(21) Appl. No.: 18/802,329

(22) Filed: Aug. 13, 2024

(30) Foreign Application Priority Data
Oct. 17, 2023 (KR) 10-2023-0138656

(51) Int. Cl. G02F 1/157; G02F 1/1343; G02F 1/155

(52) U.S. Cl. CPC G02F 1/157; G02F 1/13439; G02F 1/155

(57) ABSTRACT

Provided is a dual display device. The device includes a lower substrate, a color filter layer disposed on the lower substrate, pixel electrodes on the color filter layer, a visible light switching layer on the pixel electrodes, an electrolyte layer on the visible light switching layer, an infrared radiation layer on the electrolyte layer, and an upper substrate on the infrared radiation layer.

### CROSS-REFERENCE TO RELATED APPLICATIONS

This U.S. non-provisional patent application claims priority under 35 U.S.C. § 119 of Korean Patent Application No. 10-2023-0138656, filed on Oct. 17, 2023, the entire contents of which are hereby incorporated by reference.

### BACKGROUND

The present disclosure herein relates to a display device, and more particularly, to a dual display device capable of displaying a plurality of images.

The most basic core principle of electrochromic devices, which are widely used in smart windows in general, is to form a layer on a transparent substrate which can control the transmittance of sunlight through a material, the transmittance of which changes according to changes in the electric field. Electrochromism refers to a phenomenon in which coloring and bleaching occur reversibly due to electrochemical external stimuli. In general, the electrochromism is caused by an insertion/extraction process of electrons and ions (H⁺, Li⁺, etc.) into/from a reduction coloring/oxidation coloring material. The electrochromic material includes a transition metal oxide such as tungsten oxide, a metal complex compound such as Prussian blue, a conductive polymer, and a viologen-based material. The transition metal oxide may be classified into a reduction coloring material and an oxidation coloring material, and the reduction coloring material is a material that is formed on a cathode and becomes colored due to the insertion of positive ions into the material layer and the reduction of a metal of the metal oxide, which simultaneously occur when a voltage is applied, wherein a tungsten oxide is a representative material. On the contrary, the oxidation coloring material is a material that is formed on an anode and becomes colored due to the escape of positive ions from the material layer, which causes the oxidation of a metal, wherein a nickel oxide is a representative material. A typical electrochromic device is composed of a multi-layer structure. The typical electrochromic device is in a form in which electrochromic substances (the reduction coloring material, the oxidation coloring material, or both) are deposited in a thin film form on a transparent electrode, and an electrolyte is injected therebetween.

### SUMMARY

The present disclosure provides a dual display device capable of selectively displaying images of infrared light and visible light.

An embodiment of the inventive concept provides a dual display device. The device includes a lower substrate, a color filter layer disposed on the lower substrate, pixel electrodes on the color filter layer, a visible light switching layer on the pixel electrodes, an electrolyte layer on the visible light switching layer, an infrared radiation layer on the electrolyte layer, and an upper substrate on the infrared radiation layer.

In an embodiment, the infrared radiation layer may include multi-layer graphene layers.

In an embodiment, the visible light switching layer may include an electrochromic layer.

In an embodiment, the visible light switching layer may include a metal oxide, a viologen, or a viologen derivative.

In an embodiment, the electrolyte layer may include an ionic liquid.

In an embodiment, the pixel electrodes may include a transparent metal oxide.

In an embodiment, the lower substrate may include a reflective substrate.

In an embodiment, the lower substrate may contain aluminum.

In an embodiment, the dual display device may further include partition walls in the electrolyte layer.

In an embodiment, the partition walls may be aligned to boundaries of the pixel electrodes.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a plan view showing an example of a dual display device according to the inventive concept;

FIG. 2 is a cross-sectional view taken along line I-I′ of FIG. 1;

FIG. 3 is a cross-sectional view showing an image display principle of reflected light transmitted to a visible light switching layer of FIG. 1;

FIG. 4 is a cross-sectional view showing an image display principle of infrared light of an infrared radiation layer of FIG. 1;

FIG. 5 is a graph showing an example of normalized emitted power of infrared light according to a driving voltage provided to an infrared radiation layer of FIG. 2; and

FIG. 6 is a cross-sectional view showing an example of a dual display device according to the inventive concept.

### DETAILED DESCRIPTION

Hereinafter, preferred embodiments of the present invention will be described in detail with reference to the accompanying drawings. Advantages and features of the present invention and methods of accomplishing the same may be understood more readily by reference to the following detailed description of exemplary embodiments and the accompanying drawings. However, the present invention is not limited to the embodiments described herein, and may be embodied in other forms. Rather, the embodiments introduced herein are provided to ensure that the disclosed contents may be thorough and complete, and that the spirit of the present invention may be sufficiently conveyed to those skilled in the art, and the present invention is only defined by the scope of claims. The same reference numerals refer to like elements throughout the specification.

The terms used herein are for the purpose of describing embodiments and are not intended to be limiting of the present invention. In the present specification, singular forms include plural forms unless the context clearly indicates otherwise. As used herein, the terms ‘comprises’ and/or ‘comprising’ are intended to be inclusive of the stated elements, operations and/or devices, and do not exclude the possibility of the presence or the addition of one or more other elements, operations, and/or devices. In addition, since the present specification is according to a preferred embodiment, reference numerals presented according to the order of description are not necessarily limited to the order.

In addition, embodiments described in the present specification will be described with reference to cross-sectional views and/or plan views which are ideal illustrations of the present invention. In the drawings, the thickness of films and regions are exaggerated for an effective description of technical contents. Accordingly, the shape of an exemplary drawing may be modified by manufacturing techniques and/or tolerances. Thus, the embodiments of the present invention are not limited to specific forms illustrated, but are intended to include changes in the form generated by a manufacturing process.

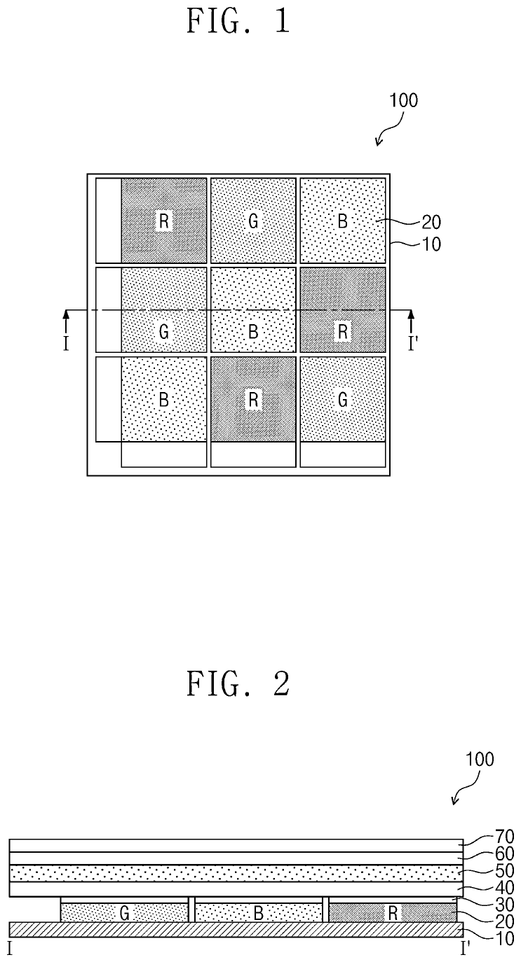

FIG. 1 shows an example of a dual display device 100 according to the inventive concept. FIG. 2 is a cross-sectional view taken along line I-I′ of FIG. 1.

Referring to FIG. 1 and FIG. 2, the dual display device 100 of the present invention may include an infrared light device and a visual light device. According to an example, the dual display device 100 of the present invention may include a lower substrate 10, a color filter layer 20, pixel electrodes 30, a visual light switching layer 40, an electrolyte layer 50, an infrared radiation layer 60, and an upper substrate 70.

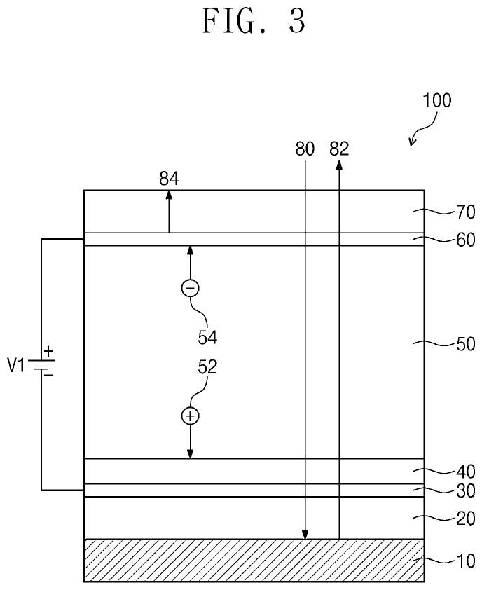

The lower substrate 10 may be provided below the color filter layer 20. According to an example, the lower substrate 10 may be a reflective substrate. For example, the lower substrate 10 may contain aluminum. Alternatively, the lower substrate 10 may contain tungsten or indium, but the embodiment of the inventive concept is not limited thereto. The lower substrate 10 may reflect external light (80 of FIG. 3).

The color filter layer 20 may be provided on the lower substrate 10. The color filter layer 20 may include an organic material layer of a polymer. The color filter layer 20 may display a red color, a green color, and a blue color.

The pixel electrodes 30 may be provided on the color filter layer 20. The pixel electrodes 30 may include a transparent electrode. For example, the pixel electrodes 30 may include an indium tin oxide (ITO). The pixel electrodes 30 may transmit the external light 80 and reflected light (82 in FIG. 3). Although not illustrated, the pixel electrodes 30 are connected to a thin-film transistor, and may receive a driving voltage applied by the thin-film transistor.

The visible light switching layer 40 may be provided on the pixel electrodes 30. According to an example, the visible light switching layer 40 may include an electrochromic layer. The visible light switching layer 40 may include a metal oxide layer of a nickel oxide, an iridium oxide, a vanadium oxide, a titanium oxide, or a tungsten oxide. In addition, the visible light switching layer 40 may include a viologen or a viologen derivative. In addition, the visible light switching layer 40 may include a metal-organic complex material. The visible light switching layer 40 may absorb or transmit the external light 80 and the reflected light 82 based on a voltage between the infrared radiation layer 60 and the pixel electrodes 30.

The electrolyte layer 50 may be provided on the visible light switching layer 40. According to an example, the electrolyte layer 50 may include an ionic liquid. The ionic liquid may include at least one of anions of bis(fluorosulfonyl)imide (FSI), bis(trifluoromethanesulfonyl)imide (TFSI), or hexafluorophosphate (PF₆), and at least one of cations of imidazolium (XMI), piperidinium (PIP), or pyrrolidinium. In the imizolium, the X may be a methyl group, an ethyl group, an isopropyl group, a butyl group, or a phenyl group. In addition, the electrolyte layer 50 may further include lithium ions. The electrolyte layer 50 may include a liquid electrolyte in which the ionic liquid and a lithium salt are mixed. The lithium salt may include Li(FSI), or Li (TSFI). The electrolyte layer 50 may be sealed between the infrared radiation layer 60 and the visible light switching layer 40 or provided in the form of an ion gel having a polymer network. Additionally, the electrolyte layer 50 may further include a solvent mixed with the ionic liquid and the lithium salt. The solvent may include ethylene carbonate, or propylene carbonate. In addition, the electrolyte layer 50 may further include a liquid or solid electrolyte, which includes a lithium salt or hydrogen ions. For example, the electrolyte layer 50 may include a porous material in the form of a gel impregnated in a solution of LiCIO4 and propylene carbonate.

The infrared radiation layer 60 may be provided on the electrolyte layer 50. The infrared radiation layer 60 may include multi-layer graphene layers. The infrared radiation layer 60 may include two to twelve graphene sheets. Thirteen or more graphene sheets may reduce the transmittance of the external light 80 and the reflected light 82. Each of the graphene sheets may be formed by a transferring method. Alternatively, each of the graphene sheets may be formed by a wet coating method of graphene flakes, but the embodiment of the inventive concept is not limited thereto. The infrared radiation layer 60 may be a flat layer formed on the entire upper surface of the electrolyte layer 50. Although not illustrated, the infrared radiation layer 60 may be arranged in a matrix form in correspondence to the pixel electrodes 30. The infrared radiation layer 60 may display an image of infrared light based on a voltage with respect to the pixel electrodes 30.

The upper substrate 70 may be provided on the infrared radiation layer 60. The upper substrate 70 may include a transparent substrate. For example, the upper substrate 70 may include a transparent inorganic material such as soda-lime glass, alkali-free glass, quartz glass, and sapphire. Alternatively, the upper substrate 70 may include a transparent organic polymer material such as polyethylene phthalate (PET), polyethylene, polycarbonate, and polyimide, but the embodiment of the inventive concept is not limited thereto. The upper substrate 70 of the organic polymer material may have a thickness of approximately 100 μm or less.

Although not illustrated, a metal mesh layer may be provided between the upper substrate 70 and the infrared radiation layer 60. The metal mesh layer may include a conductive metal of aluminum, gold, silver, platinum, chromium, or nickel. The metal mesh layer may have an area ratio of approximately 30% or less with respect to the total planar area of the dual display device 100.

FIG. 3 shows an image display principle of the reflected light 82 transmitted to the visible light switching layer 40 of FIG. 1.

Referring to FIG. 3, if a first driving voltage V1 is applied between the visible light switching layer 40 and the infrared radiation layer 60, the reflected light 82 may be emitted from the dual display device 100. The visible light switching layer 40 may absorb positive ions 52 from the electrolyte layer 50. The visible light switching layer 40 of a nickel oxide may be reduced and become transparent. The visible light switching layer 40 may transmit the external light 80 to the lower substrate 10, and may transmit the reflected light 82 to the upper outside. The external light 80 and the reflected light 82 may be visible light. Therefore, the dual display device 100 of the present invention may display a colored pixel in the visible light region in the daytime or under lighting. The infrared radiation layer 60 may absorb negative ion 54 from the electrolyte layer 50. Then the infrared radiation layer 60 may emit infrared light 84 with a low energy.

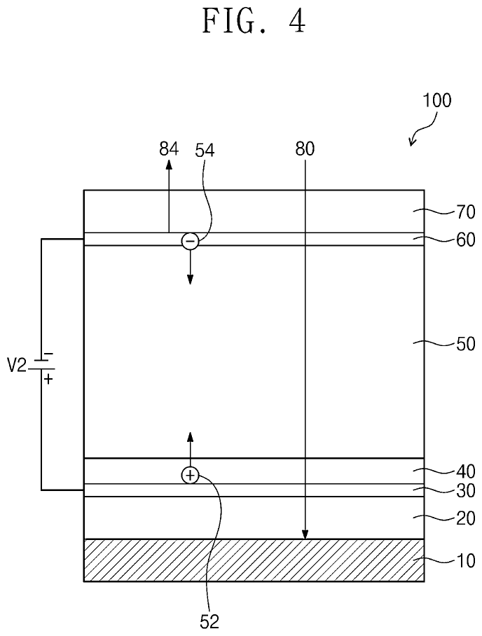

FIG. 4 shows an image display principle of the infrared light 84 of the infrared radiation layer 60 of FIG. 1.

Referring to FIG. 4, if a second driving voltage V2 is provided between the visible light switching layer 40 and the infrared radiation layer 60, the infrared light 84 may be emitted from the infrared radiation layer 60 without the reflected light 82. The second driving voltage V2 may be applied to opposite direction to the first driving voltage V1. The visible light switching layer 40 may release the positive ions 52 to the electrolyte layer 50. The visible light switching layer 40 of the nickel oxide may be oxidized and become opaque. The visible light switching layer 40 may absorb the external light 80 and the reflected light 82. Therefore, the dual display device 100 of the present invention may veil a colored pixel in the visible light region in the daytime or under lighting. The infrared radiation layer 60 may release the negative ions 54 to the electrolyte layer 50. The infrared radiation layer 60 may emit the infrared light 84. The second driving voltage V2 may emit the infrared light 64 with an energy higher than that of the first driving voltage V1.

As a result, the dual display device 100 of the present invention may display a visible light image of the reflected light 82 in the daytime, and may selectively display an image of the infrared light 84 at night.

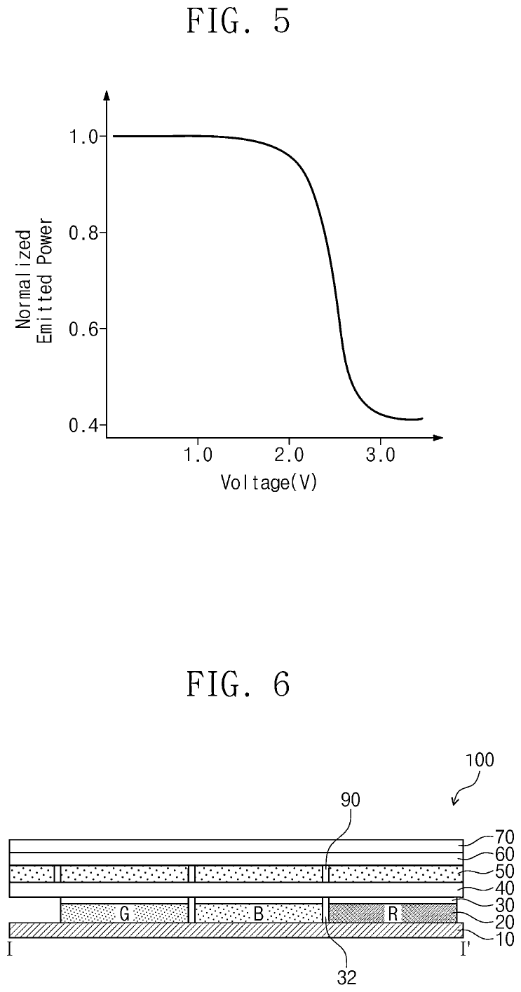

FIG. 5 shows an example of normalized emitted power of infrared light according to a driving voltage provided to the infrared radiation layer 60.

Referring to FIG. 5, the efficiency of the normalized emitted power of the infrared light 84 of the infrared radiation layer 60 may be highest at about 1.0 at about 2 V or lower, and may decrease to about 0.4 or less at about 3 V or higher. Therefore, the infrared radiation layer 60 may emit the infrared light 84 by using the second driving voltage V2 of about 2 V or lower to display an infrared image.

FIG. 6 shows an example of a dual display device 100 according to the inventive concept.

Referring to FIG. 6, the dual display device 100 of the present invention may further include partition walls 90. The partition walls 90 may be provided in the electrolyte layer 50. The partition walls 90 may be aligned to boundaries of the pixel electrodes 30. The partition walls 90 may include a dielectric of a ceramic, or an insulating polymer. Each of the partition walls 90 may have a rectangular cross-section from a vertical point of view. The partition walls 90 may eliminate electric field interference of the pixel electrodes 30 in the electrolyte layer 50, and may increase image resolution of the infrared light 84.

The lower substrate 10, the color filter layer 20, the pixel electrodes 30, the visible light switching layer 40, the electrolyte layer 50, the infrared radiation layer 60, and the upper substrate 70 may be configured the same as shown in FIG. 2.

As described above, a dual display device according to an embodiment of the inventive concept may selectively display images of infrared light and visible light by using a visible light switching layer and an infrared radiation layer on pixel electrodes.

Although the embodiments of the present invention have been described with reference to the accompanying drawings, those skilled in the art will understand that the present invention can be implemented in other specific forms without changing the technical spirit or essential features thereof. Therefore, the embodiments described above should be understood as illustrative in all respects and not restrictive.

What is claimed is:

1. A dual display device comprising:
a lower substrate;
a color filter layer on the lower substrate;
pixel electrodes on the color filter layer;
a visible light switching layer on the pixel electrodes;
an electrolyte layer on the visible light switching layer;
an infrared radiation layer on the electrolyte layer; and
an upper substrate on the infrared radiation layer.

2. The dual display device of claim 1, wherein the infrared radiation layer comprises multi-layer graphene layers.

3. The dual display device of claim 1, wherein the visible light switching layer comprises an electrochromic layer.

4. The dual display device of claim 1, wherein the visible light switching layer comprises a metal oxide, a viologen, or a viologen derivative.

5. The dual display device of claim 1, wherein the electrolyte layer comprises an ionic liquid.

6. The dual display device of claim 5, wherein the electrolyte layer further comprises lithium ions.

7. The dual display device of claim 1, wherein the pixel electrodes comprise a transparent metal oxide.

8. The dual display device of claim 1, wherein the lower substrate comprise a reflective substrate.

9. The dual display device of claim 1, wherein the lower substrate contains aluminum.

10. The dual display device of claim 1, further comprising partition walls in the electrolyte layer.

11. The dual display device of claim 10, wherein the partition walls are aligned to boundaries of the pixel electrodes.
